(19) United States
(12) Patent Application Publication
(10) Pub. No.: US 2006/0184715 A1
(43) Pub. Date: Aug. 17, 2006

(54) Method and system for exchanging description data between projects

(75) Inventors: Diamantis Gikas, Nurnberg (DE); Ronald Lange, Furth (DE); Ralf Leins, Ispringen (DE); Klaus Meusser, Furth (DE); Jurgen Schmoll, Markt Berolzheim (DE); Markus Weinlander, Happurg (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: SIEMENS AKTIENGESELLSCHAFT

(21) Appl. No.: 11/311,759

(22) Filed: Dec. 19, 2005

(30) Foreign Application Priority Data
Dec. 21, 2004 (EP) 04030322.4

(51) Int. Cl. G06F 12/14

(52) U.S. Cl. 711/100

(57) ABSTRACT

Method and system for exchanging description data between projects The invention relates to a system and a method for exchanging application-oriented description data between projects, in particular between engineering projects in the field of automation. It makes it possible to exchange description data, in particular application-oriented engineering data, between sub-projects in an efficient and reliable manner. The storage and subsequent exchange of relevant description data relating to objects, such that all the information required for communication between sub-projects is available, are ensured by means of the system and the method. The description data is stored on a shared basis in so-called inter-projcet interfaces( IPI).

### CROSS REFERENCE TO RELATED APPLICATIONS

This application claims priority to the European application No. 04030322.4, filed Dec 21, 2004 which is incorporated by reference herein in its entirety.

### FIELD OF NVENTION

The invention relates to a system and a method for exchanging application-oriented description data between projects, in particular between engineering projects in the field of automation.

### BACKGROUND OF INVENTION

Complex automation solutions are at present generally developed in a number of projects or sub-projects by teams working in parallel. Development work can even be split between different companies, for example operating as sub-contractors. Generally such projects are only loosely linked to each other. It is however necessary to communicate data describing certain characteristics of relevance to the project as a whole smoothly between the individual sub-projects so that the parallel development can continue smoothly. The relevant characteristics or data can for example be network addresses, which are the same for all the sub-projects. The required synchronization can hereby be achieved on a shared basis. The different teams synchronize and update their own data of relevance to their sub-project. In a different model synchronization can be undertaken by a central body that coordinates the sub-projects In the latter case the sub-contractors or the individual sub-projects receive the data that is of relevance to the project as a whole and therefore fixed to program the parts assigned to them.

### SUMMARY OF INVENTION

Generally in such scenarios there is no shared database or storage unit for the project. This is for example due to the absence of a database for use on a shared basis or an inadequate infrastructure, such as unsatisfactory or slow network access. At prese nt there is no reasonable support for such development scenarios, allowing the data of relevance in the engineering context to be administered and used efficiently for the sub-projects. At present users therefore have two options: they can work according to defined rules and try to comply with the agreed rules or they use the “copy insert” option to exchange project data.

An object of the present invention is therefore to enable exchange of description data, in particular application-oriented engineering data, between sub-projects in an efficient and reliable manner.

This object is achieved by the claims.

The invention is based on the knowledge that storing and then exch anging relevant description data relating to objects means that all the information required for communication between sub-projects is available. The description data is stored on a shared basis in so-called inter-project interfaces (IPI).

So-called tags are for example part of the information present in the various sub-projects, which must be identical in the respective sub-projects. To establish the exchange of data or connections for example between an operating and monitoring system, an MES syst em and a controls system, the data types, symbolic names and paths of all those global tags required by the sub-projects involved are stored in the IPI.

The stored data is for example the characteristics of objects of relevance in a number of projects. The whole object is therefore not stored in the IPIs, just some of its characteristics. The stored description data thereby has a unique identity, a so-called master ID. This identity can be used to track and update the corresponding description data. This is also possible when a number of IPIs are generated in the context of a cascade of sub-projects, so that the relevant description data of all the projects involved is always up to data and has the same status. Updating hereby takes place with the aid of time stamps.

Alarms are also stored as description data in the IPIs. To forward alarms generated by a controller for example to an operating and monitoring element (HMI element), the information about the definition of the alarm must be part of the IPI, so that it can be interpreted identically by both sub-projects. So-called function block interfaces are also part of the description data. These for example support the remote launching of a procedure or function.

To connect different devices to the same network for example, it must be ensured that the respective addresses are stated clearly and direct assignment of the addresses to the respective device must be guaranteed. To this end the addresses must also be identical in the various sub-projects, so that addresses are not confused. Therefore network addresses and further device parameters of relevance in the context of the network should for example be stored as description data in the IPIs.

In the context of a total automation solution certain devices or parts of devices or even the technological hierarchy of the devices in relation to each other must be standard and unique. This is essential for unique assignment of the devices themselves and their positioning in the technological hierarchy. It is therefore advantageous if the project structure relating to the devices and the technological hierarchy is also stored in the form of description data and is therefore part of the IPI.

By storing the description data the IPI advantageously allows prompt and smooth integration of two or even more independently developed sub-projects. It is therefore necessary to store not only the symbolic names but also for example the physical address or references to tags, alarms and other objects. Using the IPIs as a storage unit for the description data allows a form of “plug and play” for different parts of a developing automation solution. Use of the stored description data makes it significantly easier for the engineers or developers in individual sub-projects to create a corresponding engineering solution. To allow a simple exchange of information, the stored description data, i.e. the IPIs, can for example be stored in a relatively small file and be exchanged for example by email, via shared hard drives or even using USB sticks.

Generally the claimed system allows parallel work with independent projects. Relevant information such as project structure, network data, reports and symbol definitions can be identified and are available in a standard manner for the projects involved by mail or other communication means. The identity of the information can be used to exchange said information between the projects and to update it.

Further advantageous embodiments of the invention are laid down in the dependent claims.

### BRIEF DESCRIPTION OF THE DRAWING

The invention is described and explained in more detail below with reference to the exemplary embodiments illustrated in the figures, in which:

FIG. 1 shows a schematic overview of the system for exchanging description data,

FIG. 2 shows an illustration of the imported description data in a sub-project,

FIG. 3 shows the representation of an object in a sub-project,

FIG. 4 shows the merging of an object and its remote source object to runtime.

### DETAILED DESCRIPTION OF INVENTION

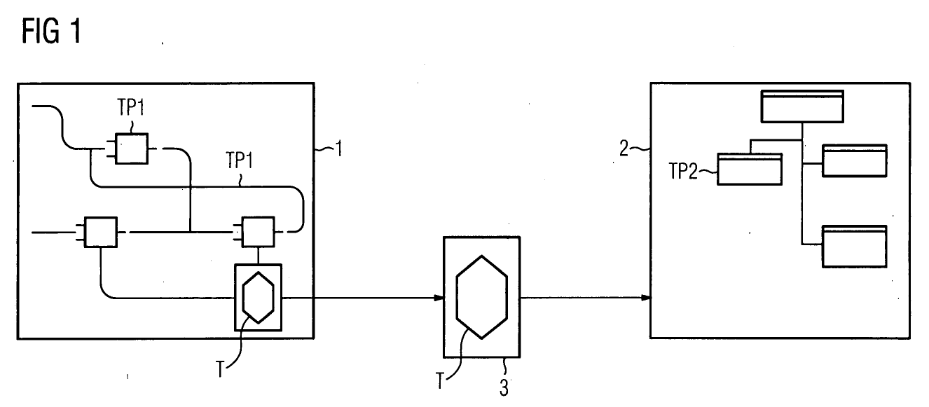

FIG. 1 shows a system for exchanging description data, which is stored in a so-called IPI file 3. For example in a first sub-project TP1, generated in a first project planning environment 1, description data of relevance to the project as a whole, for example tag definitions T, are stored in the IPI file 3. The description data is for example the characteristics or attributes of an object. The first sub-project TP1 is hereby located the in field of controller programming for an automation project, i.e. a controls project. The second sub-project TP2 is for example responsible for the areas of the operating and monitoring system. To design the operating and monitoring elements according to the project structure, the HMI project requires information about the tag definitions of the sub-project located in the controls environment. To this end an IPI is created in the first sub-project TP 1 containing the required tag information. The IPI is stored in a file, the IPI file 3, and forwarded to the second sub-project TP2. Forwarding takes place for example by email or using a USB stick. The IPI file 3 is hereby generated by the first sub-project TP1 by means of a data export. The second sub-project TP2 then imports the relevant description data of the IPI file in the project planning environment 2.

The relevant description data has a unique identity, a master ID, on the basis of which it can be assigned uniquely even after modification. Data can be amended in a sub-project on the basis of the identity with the aid of time stamps for example. The latest value of the descriptive data is always adopted in the projects when the update takes place.

In addition to the example described above, in larger development schemes a number of sub-projects can also be supplied with the description data of relevance to them via a number of IPIs. A chain of sub-projects can hereby be generated with an associated chain of IPIs. The relevant description data can also hereby be updated and aligned between sub-projects of the same hierarchy or even between projects and subordinate sub-projects, for example of a sub-contractor, by means of the unique identity and the use of time stamps.

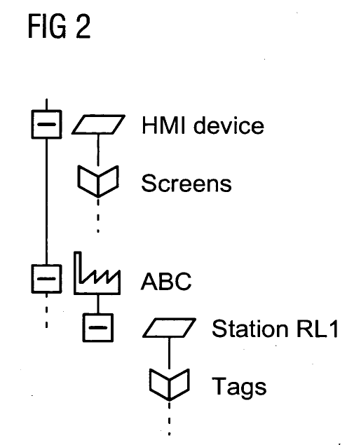

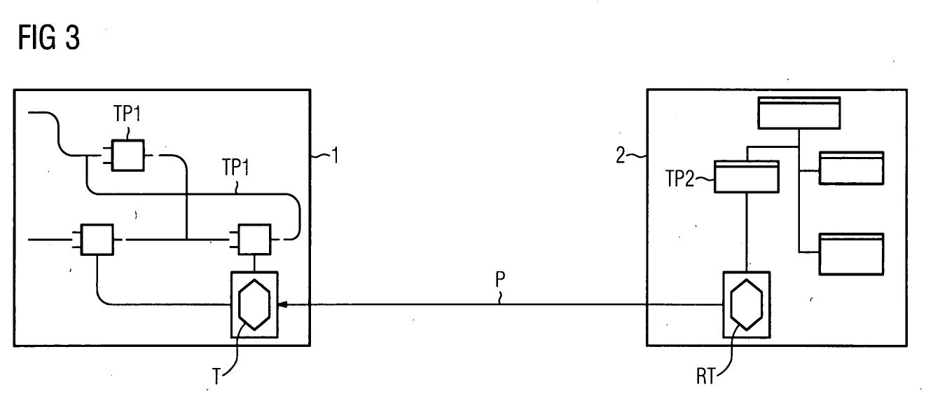

FIG. 2 shows how the imported IPI file is represented in the second sub-project TP2. To this end an additional function is implemented in the project navigator of the second sub-project TP2, allowing the representation of the imported description data, for example the tag definitions,in the structure of the second sub-project TP2. This can be done for example in the form of a standard tree structure to display or represent the project structure or elements of the project. The relevant description data is hereby simply inserted into the structure of the second sub-project TP2. The second sub-project TP2 therefore now has a remote station, for example RLl, and the associated tags of the first sub-project. FIG. 3 shows the representation of the remote object from the first sub-project project TP1 in the second sub-project TP2. Reference can hereby be made in the second sub-project TP2 to the remote object, as well as to any other tag, which might only be of relevance for example in the second sub-project TP2. The remote tag RT or remote object has a reference P to its source object. This reference for example makes it possible to update functions without losing the references or amendments made in a project. The original tag information can therefore be updated without impeding the work carried out in the second sub-project.

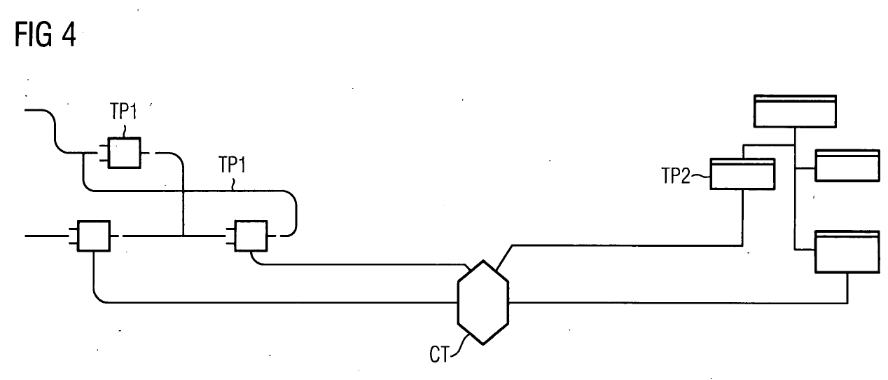

FIG. 4 shows the merging of the remote object with the original object during the course of the project to runtime. A single object CT thereby results from the two objects. This object is represented in both sub-projects, for example the project for developing an automation solution in the field of controllers and the project for operating and monitoring the automation solution. The merging of the remote object RT with the original object T also takes place when the two sub-projects TPl, TP2 are combined in the context of development or the engineering process. Merging therefore also takes place in the engineering version of the corresponding project.

It is simple for the user to create IPIs in the context of a sub-project. For example a user only needs to make known in the context of a controls project which of the tags or alarms or other super-parameters are of relevance to another project, for example an HMI project. The IPI file containing the corresponding description data is then generated automatically at the touch of a button. This can be done for example by giving every tag an attribute, for example HMI-relevant, public or global, which can for example also be a basic setting. If it is not required or if it is not global description data, the attribute, for example the user flag, can be deleted.

In the context of the corresponding system the description data is then written into the corresponding IPI by means of a function, for example “File>Export-Interfaces”. The objects written to the IPI file are still present in the original project. They can also be amended there. In contrast only the remote object representing the original object exists in the sub-project. The remote object can be updated by the user if said user once again generates an IPI file. The original object can only be updated in the source object.

1.-22. (canceled)

23. A system for exchanging application-oriented description data between projects, comprising:
a first project planning environment for creating a first sub-project;
at least one second project planning environment for creating at least one second sub-project; and
a storage unit for storing description data related to the first and second sub-projects wherein
the first project planning environment is configured to execute storage of the description data in the storage unit, and
the second project planning environment is configured to read the stored description data from the storage unit.

24. The system according to claim 23, wherein the projects are automation engineering projects.

25. The system according to claim 23, wherein the description data include a specific choice of attributes of at least one object.

26. The system according to claim 23, wherein the description data are:
exported to the storage unit by the first project planning environment, and
imported to the second project planning environment from the storage unit by the second project planning environment.

27. The system according to claim 23, wherein the description data include an identity provided for tracking purposes.

28. The system according to claim 27, further comprising an update unit for updating the description data using the identity.

29. The system according to claim 28, wherein updating the description data is based on time stamps and includes the description data of a plurality of related sub-projects

30. The system according to claim 23, wherein the storage unit includes a file suitable for storage on a floppy-disk or a USB memory stick.

31. The system according to claim 23, wherein the second project planning environment includes a navigation unit for graphically representing the second sub-project, the navigation unit configured to display the description data imported from the storage unit.

32. The system according to claim 31, wherein the second sub-project is graphically represented by a tree structure.

33. The system according to claim 23, wherein the description data include an element chosen from the group consisting of a tag, an alarm, a function block interface, a network addresses and a project structure.

34. The system according to claim 33, wherein the description data are referred to by a physical address, a symbolic name or an attribute.

35. The system according to claim 23, further comprising a further storage unit configured to store description data related to further sub-projects, wherein the first, second and further sub-projects are enabled to execute storage of the description data related to the further sub-projects.

36. The system according to claim 23, wherein the description data include global variables which cannot be amended by the second project planning environment.

37. A method for exchanging application-oriented description data between projects, comprising:
creating a first sub-project by a first project planning environment;
creating at least one second sub-project by at least one second project planning environment;
storing description data related to the first and second sub-projects by the first project planning environment; and
reading the stored description data by the second project planning environment.

38. The method according to claim 37, wherein the description data include a specific choice of attributes of at least one object.

39. The method according to claim 37, further comprising:
exporting the description data to a storage unit by the first project planning environment; and
importing the description data to the second project planning environment from the storage unit by the second project planning environment.

40. The method according to claim 37, wherein the description data include an identity provided for tracking purposes.

41. The method according to claim 40, further comprising updating the description data using the identity.

42. The method according to claim 41, wherein updating the description data is based on time stamps and includes the description data of a plurality of related sub-projects

43. The method according to claim 37, wherein the second project planning environment includes a navigation unit for graphically representing the second sub-project as a tree structure, the navigation unit configured to display the description data imported from the storage unit.

44. The method according to claim 37, wherein the description data include an element chosen from the group consisting of a tag, an alarm, a function block interface, a network addresses and a project structure, the description data referred to by a physical address, a symbolic name or an attribute.

45. The method according to claim 37, firther comprising providing a further storage unit configured to store description data related to further sub-projects, wherein the first, second and further sub-projects are enabled to execute storage of the description data related to the further sub-projects.

46. The method according to claim 37, wherein the description data include global variables which cannot be amended by the second project planning environment.
